(19) United States
(12) Patent Application Publication
(10) Pub. No.: US 2005/0182675 A1
(43) Pub. Date: Aug. 18, 2005

(54) System for converting and delivering multiple subscriber data requests to remote subscribers

(76) Inventor: Alison Huettner, Pittsburgh, PA (US)

Correspondence Address: COHEN & GRIGSBY, P.C., 11 STANWIX STREET, 15TH FLOOR, PITTSBURGH, PA, 15222, US

(21) Appl. No.: 09/998,345

(22) Filed: Nov. 30, 2001

(51) Int. Cl. G06F 17/60

(52) U.S. Cl. 705/14

(57) ABSTRACT

A system and method for delivering highly customized, natural-sounding/appearing audio and/or visual content to existing player devices, including but not restricted to wired and wireless voicemail, sound-enabled PCs, and portable MP3 or DVD players. Subscribers register with existing content providers to receive alerts and information on topics they care about (e.g., portfolio updates, financial news, sports). If a user selects the audio and/or visual delivery option, the content provider passes his or her registration and preference information to the system. The content providers then pass news information to the system, which converts it to audio and/or visuals in one of two ways. For short, formulaic messages, the system concatenates spoken phrases and clauses previously recorded by human talent and stored in a multimedia library database, to create natural-seeming audio and/or visual sequences. For longer messages, the system uses human abilities entirely—i.e., a human reader records a complete text and inputs audio and/or visual files to the system. Turnaround time in both cases is minimal, and quality is high. The system then organizes customized audio and/or visual news deliveries in accordance with user preference information and customizable playlist rules, which order the selected news information by vertical, subject, paragraph, sentence, or other dimension(s). Customized news packages are then delivered as audio and/or visuals to the listeners' player devices.

### FIELD OF INVENTION

The present invention relates to a system for converting and delivering multiple subscriber data requests, and in particular to a system for automated, customized delivery of information in multimedia format customized to preferences set by subscriber and other entities.

### BACKGROUND OF THE INVENTION

Systems for the delivery of information to multiple subscribers are generally known. An example of such a systems is a customized delivery of a subscriber's stock portfolio with timely updates over the Internet. Many brokerage houses provide such information to their clients. Many companies also deliver timely news information or specialized information to subscribers or clients of their services. Many of these services provide this information over the Internet or in special newsletters delivered by traditional mail or facsimile devices. While the Internet services are capable of providing almost instantaneous news or information as it is created, it requires the subscriber to be positioned at an Internet appliance, typically a personal computer, to receive the information. Portable devices are also being developed to access the Internet wirelessly. Such devices can provide access to mobile users of these new appliances.

However, many analysts, device manufacturers and users generally agree that mobile appliances such as cellular phones with tiny screens and limited keypad functionality are difficult to use for information retrieval. Such devices may be impossible to use while mobile. This difficulty has limited the acceptance of current mobile wireless data delivery services. One solution proposed to solve the “access” problem is the use of voice command interfaces, especially with cellular telephones. A number of systems have been developed to process text data and distribute it by voice/audio over the telephone.

Especially in the case of audio, providing customizable content delivery to those who have aural “dead zone” time, for example, those focused on a visually guided tasks such as commuting or exercising, can optimize this time or receive useful or needed information in a timely, non-obtrusive manner. Currently, there are few systems that provide anything other than impersonal broadcasts or pre-recorded material. Such systems are unable to provide timely news information that is tailored to the user's particular interests and to deliver that in a mobile format.

Accordingly, it is an object of the present invention to provide a “delivery” system that is economical and scalable by converting textual data into audio and/or visual content for customization before delivery. It is another object of the present invention to deliver information to a plurality of subscribers wherever they are located within minutes of when the information becomes available. Another object of the present invention is to provide subscriber-preferred audio and/or visual information whenever they chose to receive the information. Still another object of the present invention is to organize information into topical categories from which subscribers select preference to receive particular information. It is also an object of the present invention to decrease bandwidth requirements necessary to transport information to a plurality of subscribers by transferring information in the form of data structures to a play module where it is converted into a multimedia message and delivered to the subscriber's location.

### SUMMARY OF THE INVENTION

In general, the invention comprises a system and method for the fast delivery to end users of highly customized news in a highly convenient audio and/or visual form.

In one embodiment of the invention, a system is provided for converting and delivering multiple subscriber data requests to each subscriber or end user according to a subscriber's preference. The system comprises a router for accepting a subscriber preference and data in structured and unstructured format from a data source for the subscriber such as news or sports publisher or brokerage house and directing the unstructured data to a conversion means. The structured data is delivered to a distribution agent. The router also constructs a data frame associated with each textual data.

A first conversion means is provided to add location information about converted audio and/or visual output to each data frame associated with each such conversion. Examples of visual data are one or more frames of video, images, or illustrations. Conversion can be accomplished through manual reading or through text-to-speech conversion software. The converted audio and/or visual data is stored in a database library and is assembled and delivered, when requested by a subscriber, to the subscriber's receiving device. The converted data is stored in a database library.

A distribution agent for receiving structured data and subscriber preference data from the router is provided. It also receives unstructured data frames from the first conversion means. The distribution agent stores the data and prepares distribution lists of subscribers, if no distribution lists are provided by the data source, to receive data according to subscriber preference data. The data distribution lists with embedded user information are delivered to a distribution manager that manages the distribution of subscriber data over at least one network, typically a telecommunications network. The distribution manager also is responsible for delivering to a play module converted data from the database library and any templates stored therein for structured data before delivery of subscriber data to a subscriber.

In response to a request by the subscriber, a second conversion means, preferably part of the play module, converts said data frame and structured data to audio and/or visuals for playback. The play module sends the converted audio and/or visuals corresponding to structured and unstructured data to a subscriber receiver for playback.

The system of the present invention also preferably includes a subscriber profile database and a database for storing advertising frames.

In one preferred embodiment, the invention provides a content selection and distribution system for standard mobile devices as well as mobile multimedia devices such as portable web based appliances and G3 cellular telephones. In this embodiment the system accepts data, such as current news or stock quotes, rapidly converts the data to audio (sentences and paragraphs) and/or visuals (such as one or more frames of video), organizes the data, and distributes data tailored to the interests of users or subscribers requesting to receive it. The audio and/or visual deliveries may be made using data transport or telecommunications network and are designed to be playable over any portable or wired digital audio and/or visual device. Playback can occur anytime and anywhere, at the subscribers' convenience.

According to another embodiment, the system is configured to accept data from an application program interface (“API”) integrated into existing alert or news delivery systems at one or more content provider or data source locations, including publishers and content aggregators. The API may also be installed for use with the present invention by entities or other systems, such a corporate e-mail system, that do not currently provide delivery systems. The data generally comprises two categories: subscriber-specific information and topical/news information. Subscriber-specific information includes subscriber identification and requested preferences that can be gathered and packaged by the API. The subscriber would register with a particular content provider and request to receive content topical/news information in audio and/or visual format. Typically, the content provider is remote from the ultimate user of the information such as a subscriber.

Topical/news information includes that information which is available electronically, such as through the Internet. This information is either structured or unstructured. Structured data includes formulaic data and often consists essentially of numbers and/or named entities, for example, stock price updates, breaking sports scores, airline schedule changes or weather announcements. Unstructured data is free text of any length.

A system router accepts the various data from the API in a standard packaged format. The format for structured data may be a frame consisting of a series of slot-value pairs, which are specific to the particular domain. For example, a structured frame for stock price updates could include different slot names and different types of values from the frame for sports scores. Unstructured data can be in a similar frame, but would have one or more slot values that are free text fields of arbitrary length. Both types of frames carry publisher identification, time of publication, domain, and the like.

In this embodiment the router distributes the structured and unstructured data differently within the system. When requested by a subscriber, structured data is converted to audio and/or video by a play module and the audio and/or video is sent to the subscriber's receiving device. The conversion of structured data to audio and/or video is achieved by a second conversion means, preferably a software component of the play module, by assembling segments and templates. The system contains a multimedia library of audio and/or video segments that can be assembled to form complete audio and/or video sentences. Segments are preferably standardized for such things as a large range of numbers, percentages, dollar amounts, dates, and times; names of all securities, teams, cities, airlines, and weather options that can be covered by structured data frames; and additional linking and relational material. The system further contains a wide range of templates, which are used for organizing the segments. A template is a set of pointers to audio and/or video segments that, when played in the sequence defined by the template, constitute one complete audio and/or video sentence (or, occasionally, an audio and/or video fragment, such as a subordinate clause or phrase). Some of the segments are constants, and some are variables—values for the latter are preferably chosen by reference to specific data points in the frame associated with the template.

If visuals are included in the delivery, they can take the form of video segments depicting “talking heads,” recorded and assembled as described above; alternatively, they can be visuals illustrative of the data points communicated by the audio—for example, a pie chart showing the distribution of a subscriber's portfolio, or a calendar indicating the subscriber's travel dates. The latter type of visuals can be created either automatically from the data points in the structured data frame, or manually by human analysts.

Preferably, the audio/video segments are recorded by professional human talent, although automated devices (such as text to speech) may also be used. In a preferred embodiment, the talent carefully reads selected sentences, which are then sliced apart to form the segments. A single template selects only segments recorded by the same reader. A sentence assembled using segments and a template thus has a natural intonation contour and a specific human voice and face.

Note that each audio/video segment is associated with a corresponding text field. In alternate embodiments, the template could assemble text sentences by the same method described above, with the text delivered directly (for example, via email) or converted to audio using text-to-speech software, or converted to video or other visuals by automatic methods.

Returning to the preferred embodiment, the router distributes unstructured data to a first conversion means where it is converted to audio and/or video using human talent. In this embodiment the unstructured data news segments, such as a story or summary, are electronically provided to human talent who analyze the content to add categorization information and a summary (if no summary has been provided by the data source). The same or a different human talent reads and records the story and the summary. A digital audio and/or visual version of the recording is stored in the system. Preferably the talent is available on a 24-hour a day basis. The recordings are stored in a database or, preferably, multimedia library.

A database stores subscriber-specific information, structured news frames, and unstructured news frames with pointers to complete audio files. Each data frame has a distribution list associated with it. The distribution list specifies the subscribers who are to receive this data. The distribution list contains subscriber-specific information such as contact information and delivery preferences. If no distribution list is provided for a data frame by the data source, a system-internal agent program compares content preferences against the domain and categorization information included in the structured and unstructured data frames, and assembles a distribution list for each structured or unstructured news event. If a distribution list is provided by the data source, the agent program may augment it with subscriber-specific information such as delivery preferences. Distribution lists are divided by carrier, and the resulting lists of device addresses, with a copy of the associated news event frame, are routed to the carrier-specific play modules.

Also stored in a database are subscriber profiles and advertisement targeting information. The system's distribution agent compares profiles with targeting information, and creates a distribution list of appropriate recipients for each advertisement. These lists are divided preferably by carrier as well and sent to the carrier-specific play modules, together with a pointer to the appropriate audio and/or visual advertisement. However, the advertisements are not played until news frames arrive at the carriers.

Subscribers' news organization preferences are sent to the play modules associated with individual carriers separately or as information embedded in distribution lists attached to the data frames. When sent separately, these preferences are not used until the news frames also arrive at the play modules and the subscriber requests the news event.

Each play module has available a local copy of the multimedia library, including all segments, templates, audio and/or video news stories, any other visuals, and audio and/or visual ads and includes a second conversion module. At play time, for example, when the subscriber requests a news delivery or stock market update, the playlist generation rules—a subscriber's organizational preferences, together with default playlist rules which the subscriber has not configured (or which are not configurable)—construct a playlist and manage the frame-to-audio and/or visual conversion.

The playlist is the ordered list of delivery items (structured or unstructured news, advertisements, sponsorship messages, etc.) to be played during a single audio and/or visual transmission to a single subscriber. It organizes items received at different times and from different sources into an orderly and pleasing program. The items to be organized have various levels of granularity. An unstructured news item or an advertisement is typically listed as a single item, whereas structured news events are listed at the sentence (or even clause or phrase) level—that is, each sentence is specified individually on the playlist, with the playlist itself organizing the sentences into coherent paragraphs. Playlists are constructed dynamically by the playlist generation rules.

Playlist generation rules order the waiting information by publisher and by domain; within domains, they organize it by topic; they select templates for structured data frames; and they organize the templates in such a way as to assemble coherent paragraphs. The templates select audio and/or video segments from the local copy of the multimedia library to assemble coherent sentences. As the playlist is assembled, complete audio and/or visual files and discrete audio and/or video segments are played in order to output an organized, customized, natural-sounding news program tailored to the individual listener.

Once the playlist has been played, further playlist rules govern its destruction. If a large amount of news has accumulated un-played in temporary storage at the carrier, still other playlist rules remove redundancies, keep it up-to-date, and warn the subscriber of its greater length at playtime.

Subscribers can configure their preferences to send different kinds of information to different portable devices. For example, a subscriber might want stock market updates and summaries sent to the subscriber's cell phone voicemail as promptly as possible, while the full texts of stock market news stories are sent to the subscriber's OnStar™ device, to be listened to while driving home from work. Another subscriber might want national and local news sent to her OnStar™ device to enliven a lengthy commute, while sports and obituaries from her hometown newspaper are loaded onto her MP3 device for listening at greater leisure.

In another embodiment, a database module is used instead of a router for accepting a subscriber preference, distribution lists and data in at least one of structured and unstructured format from a data source of said subscriber. A first conversion means is provided as in the previous embodiment, but in this case it obtains any of the unstructured data from said database module, converts textual data to at least one of audio or visual data and stores the converted data in a multimedia database library. A multimedia database library is provided for storing converted data, templates, media segments, media advertisements, and media news. At least one and preferably a plurality of second conversion means for converting structured data to an associated one of at least audio, visual or video previously recorded is provided, typically as part of a play module. A distribution agent is provided for obtaining structured data and subscriber preference data from the data module, creating a data frame associated with each such data, obtaining unstructured data frames from the first conversion means or said database module (after data frame has been proceeded by first conversion means), storing such data, and preparing distribution lists of subscribers according to subscriber preference data, when no distribution list is provided by a data source. A distribution manager manages the distribution of subscriber data over at least one network to at least one of the second conversion means for converting data from said multimedia database library and any templates stored therein for structured data, for delivery to a subscriber for playback of converted audio and/or visual data.

In alternate embodiments, the play module and its local copy of the multimedia library can be internal to the system or reside externally on the subscriber receiver, servers hosted by service provider for the subscriber receiver, third-party servers, or other locations. Alternatively, the second conversion means may also be part of an externally hosted play module or form a part of the software residing on the aforementioned locations.

The invention can provide for interactivity. For example, subscribers can have the option of modifying their preferences on the fly, using interactive prompts through a cell phone or the like. Other advantages of the present invention will become apparent from a perusal of the following detailed description of a presently preferred embodiment taken in connection with the accompanying drawings.

### BRIEF DESCRIPTION OF THE DRAWINGS

FIG. 1 is a block diagram showing a high-level view of the system, with inputs and outputs shown from the point of view of the subscriber and the content providers;

FIG. 2 is a flowchart representation of a presently preferred embodiment of the invention;

FIG. 3 is a flowchart of the data flow within an embodiment of the conversion means of the present invention;

FIG. 4 is a schematic data representation of a subscriber record stored in a distribution agent in one embodiment of the present invention;

FIG. 5 is a schematic data representation of a delivery preference record stored for use by the distribution agent in a preferred embodiment of the present invention;

FIG. 6 is a schematic data representation of a content preference record stored for use by the distribution agent in a preferred embodiment of the present invention;

FIG. 7 is a schematic data representation of a structured news event record stored in for use by the distribution agent in a preferred embodiment of the present invention;

FIG. 8 is a schematic data representation of an unstructured news event record stored in the distribution agent of FIG. 2;

FIG. 9 is a schematic data representation of a subscriber profile record stored in the distribution agent in an embodiment of the present invention;

FIG. 10 is a schematic data representation of an advertisement record stored in the distribution agent in a preferred embodiment of the present invention;

FIG. 11 is a schematic data representation of a playlist preference record stored in a distribution agent in a preferred embodiment of the present invention;

FIG. 12 is a schematic data representation of a distribution list for routing an audio and/or visual version of a structured news event to public carrier voice mail, telemetry systems, and their end subscribers;

FIG. 13 is a schematic data representation of a distribution list for routing an audio and/or visual version of an unstructured news event to public carrier voice mail, telemetry systems, and their end subscribers;

FIG. 14 is a diagram representing a template for constructing sentences and their audio counterparts from FIGS. 7 and 8;

FIG. 15 is a schematic data representation of records for storage of sentence segments and variable phrases for use in templates;

FIG. 16 is a schematic data representation of the rules for organizing templates by vertical content (e.g., sports, weather, financial), by publisher, by paragraph, sentences or clause;

FIG. 17 is a flowchart representation of one possible implementation of the invention described with respect to FIG. 2 using Enterprise Java Beans, Oracle Databases and XML data interchange; and

FIG. 18 is one possible logical model of the database tables for data from FIGS. 3-16 for the system shown in FIG. 2.

### DETAILED DESCRIPTION OF THE INVENTION

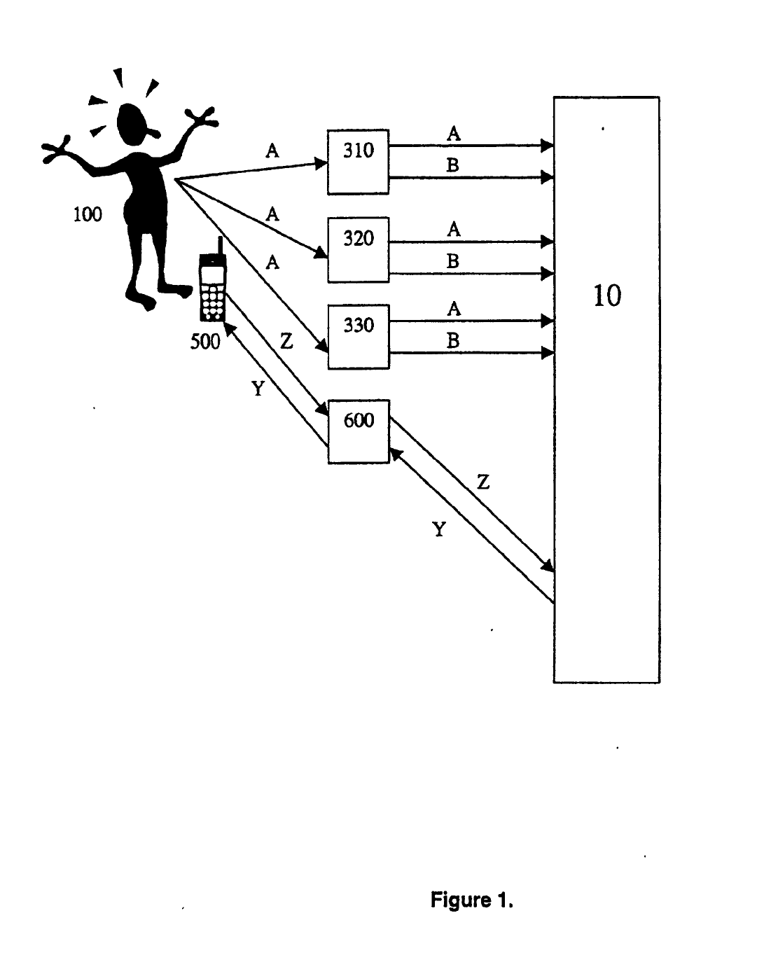

Referring to FIG. 1, a presently preferred embodiment of the invention is illustrated in conjunction with existing automated news delivery services that are provided to registered subscribers. The system 10 of the present invention relates a subscriber 100 through a communication device 500, such as a mobile phone or an OnStar™ device, connected to a carrier 600. Alternatively, device 500 can be a PC and 600 can be an entity hosting one or more servers streaming audio/video. Subscriber 100 provides user registration and preference information 100A to a data source 310, 320, and 330 that provides user registration information 100A and news content 310B, 320B and 330B to system 10. System provides audio and/or visual conversion of the news content 10Y to carrier 600 on command of subscriber by command signal 500Z/600Z through the carrier to system 10.

Typically, data sources 310, 320, and 330 provide news updates or other requested topical information over the Internet. Subscribers register directly with the services by providing preference information to one or more content providers, generally by means of a selection screen offered at the content providers website. When used with the present invention, the content provider provides subscriber-selected information to the present invention that is made available to subscribers who have selected audio and/or visual delivery as a preference. Content providers may also send news, in addition to subscriber selected news, as soon as such item is “published”. Once received in the present invention, the incoming textual content is converted to audio and/or visual format, utilizes the registration and preference information of the subscriber to assemble a customized audio and/or visual news program, and delivers that program to the subscriber's player device, when requested by the subscriber.

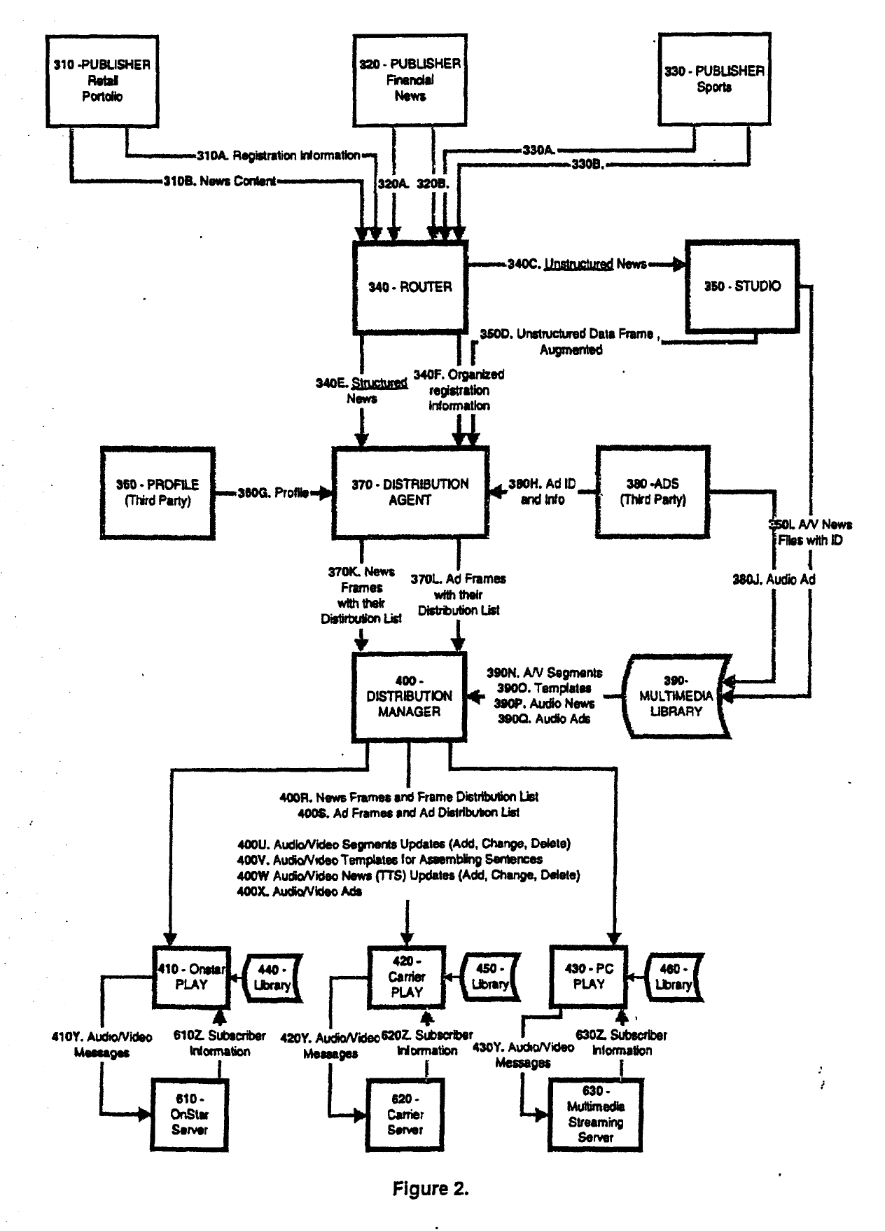

The architecture of system 10 according to a presently preferred embodiment of the invention is shown in FIG. 2. Data sources including on-line content providers such as publishers, content aggregators and other data sources integrate the systems of the present invention API into their existing alert or news delivery systems. Different versions of this API may be implemented for specific domains, such as a portfolio provider 310, financial news provider 320, sports provider 330, and the like. When a subscriber signs up to receive information from a data source, the subscriber has the option, for example, to request to receive audio and/or visual versions in addition to text or SMS messages. The subscriber typically registers with the data source through the source's web page or other means such as the post. Publishers 310, 320 and 330 are configured to communicate through system API and the present invention is capable of accepting data from the various data sources. In a first step of a presently preferred embodiment, the system receives a subscriber registration information 310A, 320A and/or 330A that has been gathered by the respective data sources. A data source passes information 310A, 320A and 330A, respectively, from the data source, for example, over the Internet or by direct connection to Router 340 within system 10 infrastructure.

Included in this information transmitted within 310A, 320A and 330A is subscriber registration information such as an ID number, the subscriber's name and contact information, mailing and e-mail address(es), wired and portable telephone numbers, and the like. It also includes a subscriber's preferences, such as content domains (e.g., portfolio, sports, weather, industry news), particular subjects (e.g., individual stocks, favorite sports teams, frequently-visited cities, topics of interest), optional thresholds (e.g., send an update if Compaq trades 3% above its opening price), optional organization preferences (e.g., instructions for generating the playlist), and delivery instructions (i.e., which information in which format should be sent to which device).

In addition to registration information, data sources 310, 320 and 330 receive news content or events 310B, 320B and 330B from providers of data. Typically, the providers are on-line or Internet-based providers. Each event 310B, 320B and 330B is typically provided by the provider to a data source or publisher into a standard format for packaging. Once packaged, content 310B, 320B and 330B is delivered to system Router 340.

System Router 340 accepts various content 310B, 320B and 330B from the API in a standard packaged format. The format for structured data may be a frame consisting of a series of slot-value pairs, which are specific to the particular domain. For example, a structured frame for stock price updates could include different slot names and different types of values from the frame for sports scores. Unstructured data can be in a similar frame, but would have one or more slot values that are free text fields of arbitrary length. Both types of frames carry the publisher identification, time of publication, domain, and the like of the publisher or data source.

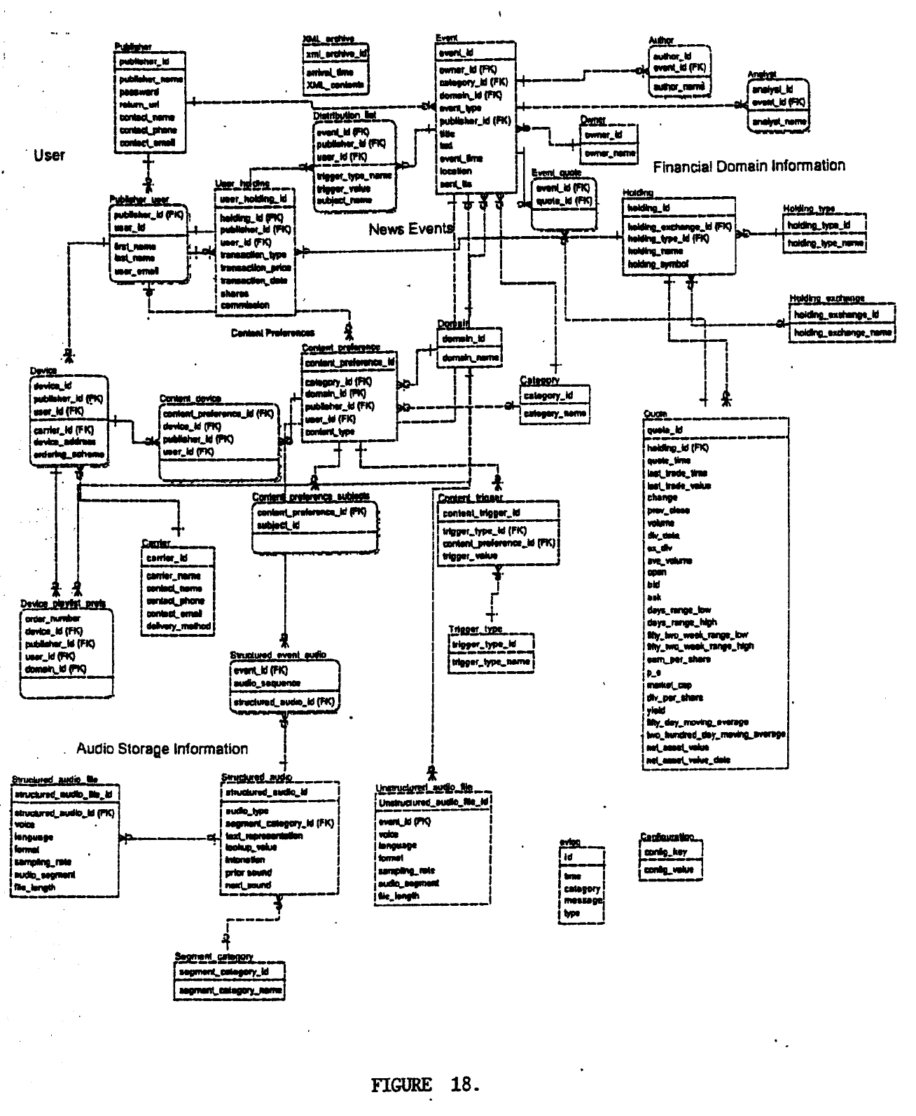

Upon receipt of information, Router 340 sorts and organizes subscriber registrations contained in data streams 310A, 320A and 330A and may remove any duplicates. If a subscriber has accounts with different data sources, there is an entry in the user database (see FIG. 18) corresponding to each data source. Each entry also specifies the device address for the subscriber receiver 500 (FIG. 1). For example, for a cell phone, the address can be the cell phone number. The play module, described herein below, is responsible for ensuring that the events from the various data sources are all organized and delivered to the specified device address.

Router 340 then passes organized subscriber registration data 340F to Distribution Agent 370. Router 340 organizes content 310B, 320B and 330B and distinguishes structured data from unstructured data. It routes structured data 340E to Distribution Agent 370 and unstructured data 340C to a conversion means 350, for example Studio, where it is converted to audio and/or video format. This can be achieved by voice/video synthesis software or human talent. Other visuals can be created and stored in the multimedia library at this time. Structured data 340E is data that is formulaic and (in most cases) consists primarily of numbers and/or named entities—for example, stock price updates, breaking sports scores, changes in airline schedules, or weather alerts. Unstructured data 340C is free text, for example, summaries to full articles. Router 340 routes structured 340E and unstructured data 340C to separate modules.

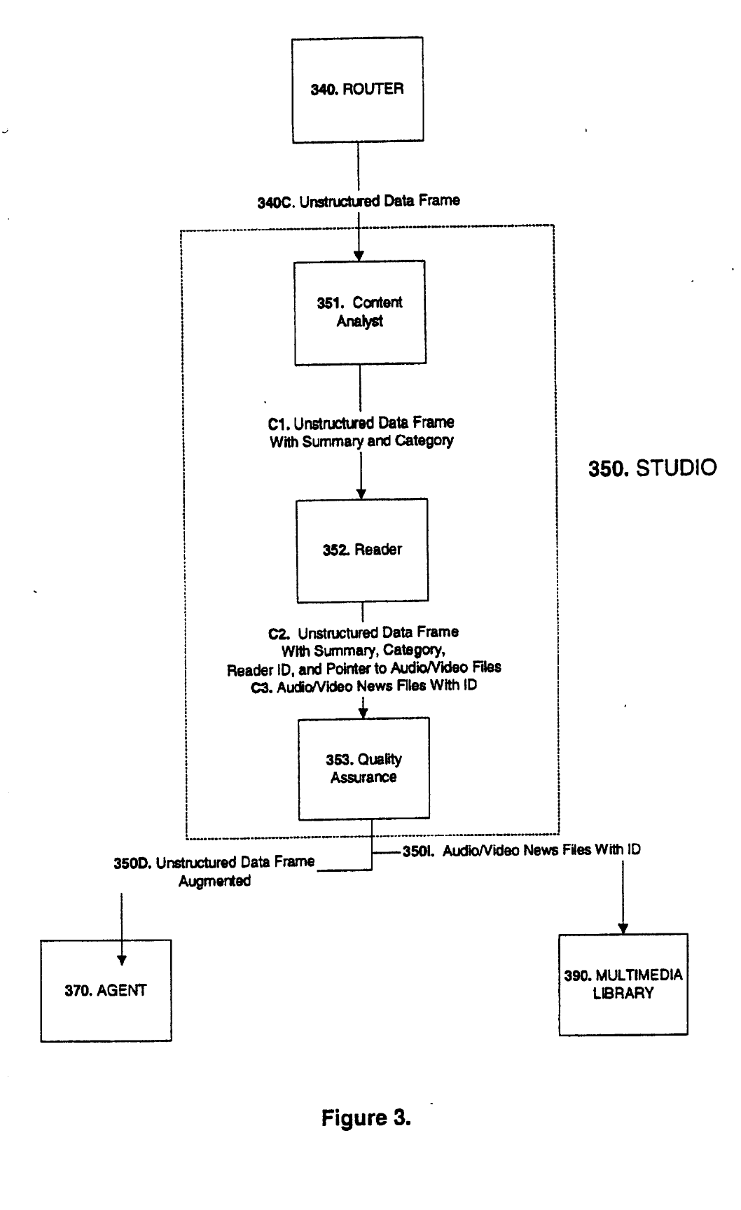

The first conversion means (e.g., Studio 350) receives unstructured data 340C (free text) from Router 340 where it is queued and routed through a series of steps before passing them on to Distribution Agent 370. For example, categorization information and a summary are preferably added, and the full article and the summary are read aloud to convert them to audio and/or video files. (See FIG. 3 for more information on the queue and these steps.) Additional visuals can also be created and stored at this time. An unstructured data frame 350D (340C with additional information) is routed to Distribution Agent 370 and the audio and/or visual files 350I are sent to a database (see FIG. 18) in a Multimedia Library 390.

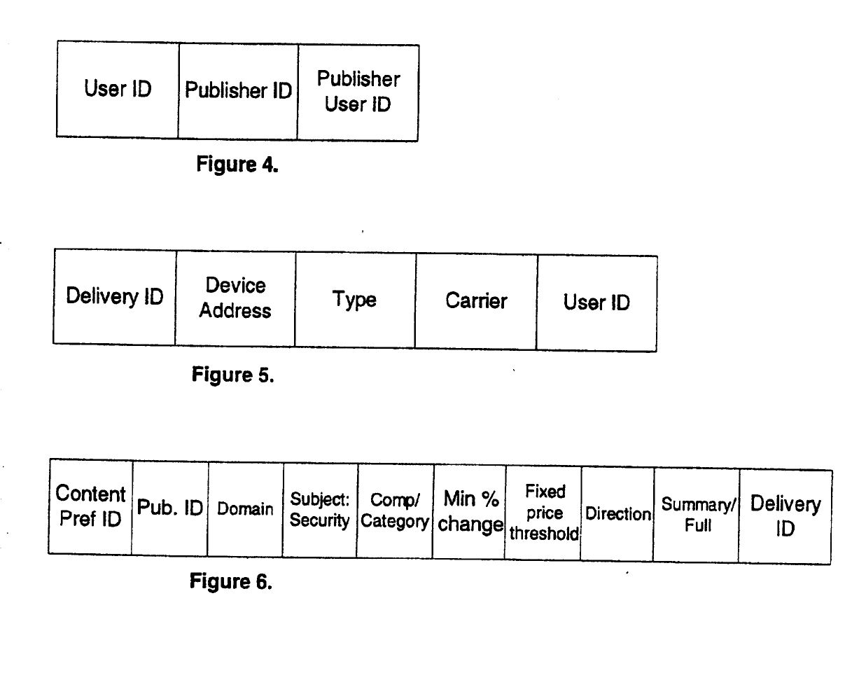

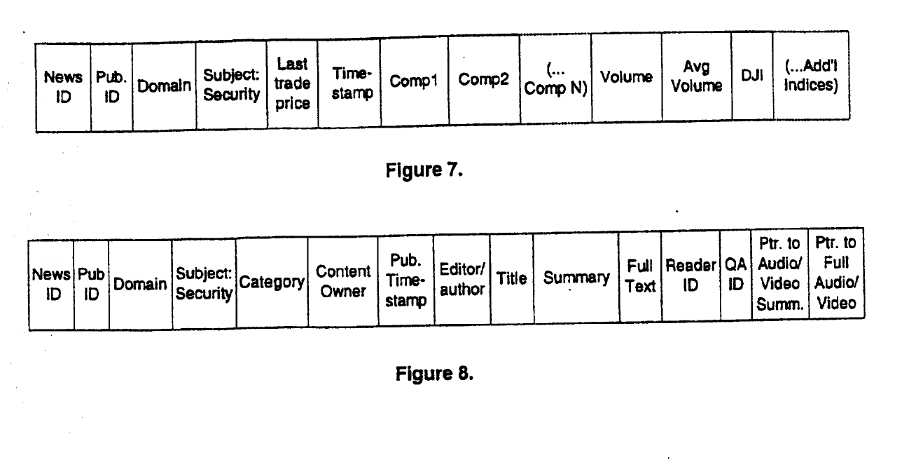

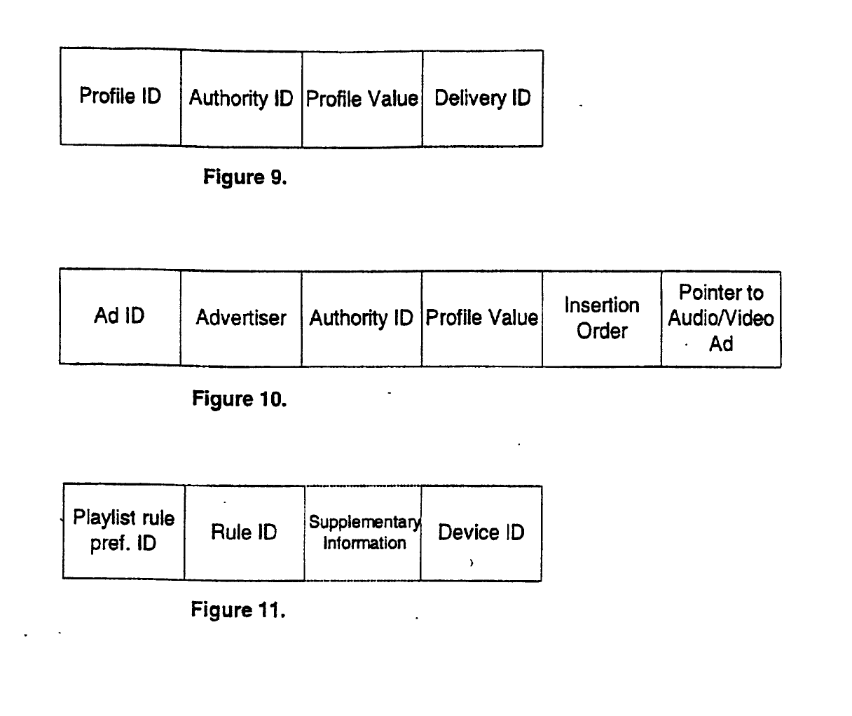

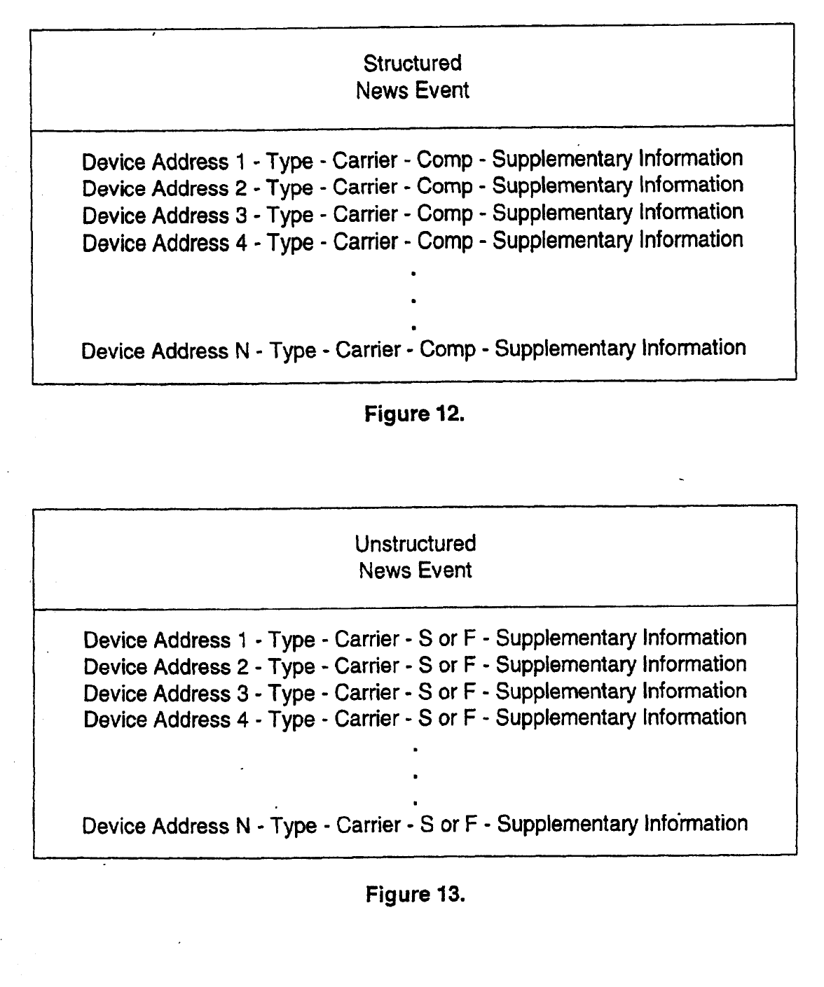

Distribution Agent 370 performs several operations. These operations include:
Storing subscriber registration information 340F received from Router 340 as a set of related records in linked database tables (FIG. 18): subscriber records (FIG. 4) are linked to delivery device records (FIG. 5), to playlist preference records (FIG. 11), and to content preference records (FIG. 6)
Storing news event frames (structured data frames) 340E received from Router 340 as records in a database table (FIG. 7)
Storing news event frames (unstructured data frames) 350D received from Studio 350 as records in a database table (FIG. 8)
Storing subscriber profiles 360G received from profile 360 as records in a database (FIG. 9), linking them to device records (FIG. 5)
Storing advertisement information 380H received from Ads 380 as records (FIG. 10) to be compared with profile records (FIG. 9)
Creating distribution lists, if required, for news (FIG. 12-13) and advertisements
Passing news event frames 370K and advertising frames 370L, with their distribution lists, to Distribution Manager 400

Playlist generation rules are rules for organizing data such as news and advertising material for one or more subscribers. These rules are stored in the play modules or agents described hereinafter. They include rules for the construction and destruction of a delivery, organization, advertisement insertion, and talent selections. There are default playlist generation rules defined for all subscribers. In one embodiment, a subscriber can customize these rules according to individual needs.

Profile 360, a third-party external profiling engine, generates profiles 360G and associates them with specific subscribers. In an alternate embodiment, the profiling functionality can be performed by system 10 from FIG. 1. Internal data may be used to generate the profiles, though the system shown in FIG. 2 does not do so. Profile 360 selects appropriate profiles based on independent information about a particular subscriber. Profiles may be of any type, such as demographic, geographic, psychographic or affinity group. Profile 360 sends the profiles 360G to Distribution Agent 370 associated with subscriber IDs. In a preferred embodiment, the subscriber ID is a combination of the Publisher ID and the user ID for that subscriber issued by the Publisher.

Ads 380 sends insertion orders for audio and/or visual advertisements 380H to Distribution Agent 370. The order indicates the profile of target subscribers for a particular advertisement (using, e.g., VALS or Claritas categories); or, for example, an associated sponsor (e.g., a Brokerage sponsorship message should be distributed with Brokerage content to the affinity group profiled as “Broker investors”). Ads 380 sends the actual audio and/or visual commercial messages 380J, with subscriber ID information, to the database library 390. Ads 380 can store the insertion order locally, or it may obtain the insertion order through an ad distribution network such as Doubleclick. Ads 380 may obtain the actual audio and/or visual advertisement locally, or it may obtain the audio and/or visual ad from an ad distribution network.

If a data source provides a distribution list for a news event, Distribution Agent 370 preferably validates it. If no distribution list is provided, Distribution Agent 370 preferably performs the following operations:
Compares an individual subscriber's content preferences against the domain and subject fields for data such as news events (for structured and unstructured data)
Performs calculations (for structured data)
Compares the subscriber's profile against target profile information (on commercial messages)
Prepares individual subscribers' playlist generation rules or information used by rules to be included in the distribution list.
   to create distribution lists. A distribution list indicates the set of devices to which a particular news event or commercial message should be delivered. Distribution Agent 370 passes structured and unstructured data 370K, advertisements 370L, with their associated distribution lists, to Distribution Manager 400. It should be noted that Distribution Agent 370 is not always responsible for building the distribution lists for every structured, unstructured news event or ad. This is the case for advertisements, but not for a structured or unstructured news event. For an unstructured or structured news event, Distribution Agent 370 builds distribution lists only if none are provided by the data sources 310, 320, or 330. There are four scenarios that can be considered. All or fewer than all can be implemented. For example:

a. A data source (e.g. 310) provides distribution lists along with every news event. Distribution Agent 370 validates the list, augments (only if required) each subscriber item in the distribution list with additional subscriber information used by downstream modules 400, 410, 420, or 430, and passes on the events with the augmented distribution lists to Distribution Manager 400.

b. A data source (e.g. 310) provides subscriber information in one transaction and Distribution Agent 370 stores this registration information in a database. In a later transaction, the same data source 310 sends a structured or unstructured news event with no attached distribution list. Distribution Agent 370, as described above, uses previously stored subscriber information to construct a distribution list for the news event and passes on the event with the attached distribution list downstream.

c. A data source (e.g. 310) provides subscriber information in one transaction and Agent 370 stores this registration information in a database. Later, a different data source, sends a structured or unstructured news event with no attached distribution list, as the latter data source has no information about subscribers belonging to 310. Distribution Agent 370 then assembles a distribution list for that news event with the help of the subscriber information provided by data source 310. For example, data source 310 may be Charles Schwab and the second data source may be Bloomberg News Service.

d. A data source (e.g. 310) provides subscriber information in one transaction and Distribution Agent 370 stores this registration information in a database. A different data source provides data that is used to construct both the news event and the associated distribution list with the help of subscriber information provided earlier by data source 310. For example, data source 310 may be Charles Schwab providing subscriber preferences as to which stocks to track and when to send them a structured news event about price movement. The second data source may be Bloomberg providing stock quotes every 5 minutes for all publicly traded stocks. The system 10 continuously processes the quotes from the second data source to determine for each stock, which subscribers should now get a price movement event. It then composes the news event, builds the associated distribution list of all subscribers that need to be informed, and passes the event with the distribution list downstream to Distribution Manager 400.

Distribution Manager 400 divides distribution lists by network delivery system carrier, for example, telecommunication providers, wireless broadband or the like. For example, from one inclusive list, it may create separate lists for Verizon, AT&T; and other servers, as well as for individual player devices such as home PCs (which may have only one or two subscribers). Distribution Manager 400 also manages delivery of the audio and/or visual material 390N, 3900, 390P and 390Q from the Library 390 such that it is sent to the player devices before any templates or playlists that require that material are processed.

Multimedia Library 390 is a database (or table within a database, e.g. FIG. 18) that contains:
Human-recorded audio and/or video segments for structured news;
Templates for constructing complete sentences out of human-recorded audio and/or video segments;
Human-recorded full texts and summaries, delivered to Multimedia Library 390 from Studio 350;
Additional visuals illustrative of structured or unstructured text; and
Audio and/or visual advertisements and sponsorship messages, delivered to Library 390 from Ads 380.

All of the audio and/or visual files from Library 390; that is—segments 390N, templates 3900, audio news articles (full text and/or summary versions) 390P, and advertisements 390Q —are provided to Distribution Manager 400. Distribution Manager 400 delivers the structured and unstructured data 400R and advertisements 400S, with the associated carrier-specific distribution lists, to Play modules 410, 420, and 430. The distribution lists also include subscriber-specific information used by playlist generation rules. Parameters used by playlist rules and the rules themselves can be included as part of subscriber information in a distribution list. In addition, these parameters and/or the rules can be stored in the subscriber database maintained by Distribution Agent 370 and Play modules 410, 420, and 430 maintain copies of these databases.

Play modules 410, 420, and 430 work with play devices at the receiving end for the subscriber, whether the device is a voicemail server 620 in Poughkeepsie, a server streaming audio and/or visuals 630 to subscribers' home PCs, or a subscriber's home PC itself, for example. Play modules 410, 420, and 430 receive data such as news events 400R and commercial messages 400S, with their carrier-specific distribution lists, with embedded subscriber information used by playlist generation rules, plus the full set of audio and/or visuals 400U and template files 400V from Distribution Manager 400. Play modules 410, 420, and 430 manage the audio and/or visual and template files libraries 440, 450 and 460, respectively, as local copies of Library 390. Play modules 410, 420, and 430 can be resident on a playback device, on a carrier location, or third party server, or other locations.

In a presently preferred embodiment of the invention, a template 400V is essentially a sentence structure that can be used to communicate a portion of the information contained in a structured data frame. It is associated with a structured news frame and a subscriber's preference tag. It consists of a set of pointers to audio and/or visual segments in a local library, some of which are fixed, and some variable, to be filled in on the basis of frame information. For example, a subscriber may have chosen a threshold of “3% above the opening price” for news about Compaq Computer. A news event arrives containing the information that Compaq is now at $1.04, together with a great deal of comparison information, including the fact that Compaq opened in the morning at $1.00. Since the news frame meets the subscriber's selection criteria ($1.04 is more than 3% above $1.00), Distribution Agent 370 places the subscriber's device address on the distribution list for the news event, together with a tag indicating that “opening price” was the factor used in selection for that particular subscriber. (Note: this processing is not necessary in scenario (a) above on Page 14.) Play module 410, 420, or 430, if the subscriber's device address is on the distribution list to receive such news, then selects a template (sentence structure) that explicitly compares the current price to a lower opening price. A choice of several templates is available for each individual preference value, to build in variety. The template is completed using the appropriate specific information in the structured data frame. In the current example, the audio and/or video segments 4 percent and 1 dollar are inserted into a sentence frame to complete an audio and/or video sentence: for example, This represents a 4 percent increase over today's opening price of 1 dollar.

When a subscriber requests the playlist over voicemail 620, OnStar™ 610, or multimedia streaming server 630, Play module 410, 420, or 430 dynamically constructs the playlist, selects the templates, calls the appropriate segments, and plays the composed audio and/or visual events for the subscriber directly or with the help of carrier side servers. (The one exception is delivery by MP3 player; in this case the delivery is constructed in advance and downloaded as a single file to the player device.) The template consists of pointers to fixed audio and/or video segments from Library 390, interspersed with pointers whose values are calculated on the basis of one or more data points in the structured news event, then looked up in the library. Within play modules 410, 420, or 430:
The distribution lists 400R and 400S determine which particular news events and commercial messages the subscriber will receive;
The playlist generation rules order the messages by domain (e.g., portfolio) and by subject (e.g., Compaq Computer news);
The playlist generation rules also remove redundant, conflicting, or obsolete messages;
The playlist generation rules select appropriate templates for the messages to be delivered; within a subject, the rules ensure that there is a topic sentence, followed where required by other new information followed by background information (paragraph structure is preferably not subscriber-configurable); and
The playlist generation rules vary sentence structures and voices in a pleasing way.

Once the subscriber has listened to a particular playlist, s/he has the option of saving it on the local library 440, 450, or 460 attached to the play module. Since the playlist is managed as a set of pointers by the play module, it does not take up any of the (generally limited) voicemail minutes that the subscriber has available. Storing the playlist as a set of pointers instead of an audio file also significantly reduces storage space consumption on the local library.

FIG. 3 shows the data flow within Studio 350 where unstructured text is converted to audio and/or visuals. The Router 340 passes unstructured data frames into Studio 350, which is essentially a complete audio and/or video studio. The frames are routed through the following steps:

First, a content analyst 351 skims the article and creates a summary, if a summary has not been provided. Content analyst 351 also chooses one or more subjects and categories for the article from a fixed inventory of subjects and categories. In the portfolio domain, a subject is generally the names of one or more securities (e.g., Compaq, IBM); categories include, e.g., management changes, insider trading, analyst downgrades/upgrades, earnings warnings, etc. Content analyst 351 delivers the story with its summary and category(s) C1 to a reader 352. If additional visuals are required, the content analyst creates them at this time.

The reader 352 reads the summary and the story separately into a microphone in front of a camera, and records digital audio and/or video files for each. He or she adds to the unstructured data frame a reader ID and pointers to the two audio and the two video files. The reader passes the augmented data frame C2 and the multimedia news files with ID tags C3 to Quality Assurance (QA) 353.

Quality Assurance 353 reviews the summary and category(s), and audio and/or visual files after the recording is performed, returning the frame C2 and files C3 to the content analyst 351 or the reader 352, as necessary, if there are errors. If there are no errors, QA 353 passes the augmented data frame 350D to the Distribution Agent 370 and the audio and/or visual files 350I to Library 390.

FIGS. 4-16 provide simplified illustrations of the database structure used for routing news in the “personal portfolio” domain. FIG. 18 is a more detailed logical model with cross-referencing between tables. News in other domains (sports scores, airline schedules, weather, etc.) is handled in similar fashion to portfolio news data, although the number of fields in a record (especially for the records in FIGS. 6-8) and the labels for those fields will vary.

FIG. 4 shows a record structure for subscriber records, consisting of a unique subscriber ID number, a data source or publisher the subscriber is registered with, and the publisher's ID number for that subscriber. The subscriber ID number may be the same as the publisher's ID number for the subscriber. Each subscriber record also contains contact information and domain-specific information (for example, subscriber's stock portfolio) used to build structured audio and/or visual events. There is preferably a separate subscriber record in the table for each data source or publisher the subscriber has registered with.

FIG. 5 shows a record structure for subscriber playback devices. These records consist of a unique device ID number, a device address (email address, cell phone number, etc.); a type field, indicating the type of device (PC, MP3 player, cell phone, voicemail, etc.); a carrier field (Verizon®, AT&T®, etc.); and a subscriber ID pointing back to a subscriber record (FIG. 4).

FIG. 6 displays a record structure for subscriber content preferences. The content preference table includes all the content preferences registered by end subscribers of the system. Each record includes a plurality of fields including: a unique ID number; a publisher ID; a domain (portfolio, sports, etc.); a subject (in the portfolio domain, this will be a security selected by the subscriber); a comparison field, indicating the comparison of interest to the subscriber (“comparison” indicates a baseline parameter such as ask, bid, today's opening price, yesterday's closing price, 50-day moving average, etc.; “category” indicates a type of news such as management change, insider trading, analyst downgrade or upgrade, earnings warning, etc.); a minimum percent change field, indicating the percent the security's current price must move above or below the selected parameter in order to satisfy the preference; alternatively, a fixed amount field, indicating a price that the security's current price must move above or below in order to satisfy the preference; a direction field, indicating whether the threshold is for upward or downward movement; and a field indicating a preference for a summary of unstructured text or for the full text. Preferably, the minimum percent change, fixed price threshold, and direction fields are used only when the subscriber has selected a “comparison” rather than a “category”—i.e., they are used with structured rather than unstructured news events. Also, the minimum percent change and fixed price threshold are mutually exclusive—one or the other may have a value, but not both. The summary vs. full field is used only when the subscriber has selected a “category” rather than a “comparison”—i.e., they are used with unstructured rather than structured text.

FIG. 7 shows an abbreviated version of a record structure for an incoming news event. There is one record for each news event. For example, in the portfolio example, for each movement of a given stock price, there is a record. The record includes a plurality of fields including: a unique event ID; a publisher ID; a domain (e.g., portfolio); a subject (security name); the last trade price (i.e., the price to which the stock has most recently moved); one or more timestamps (indicating last trade time, publication time, or both); a large number of possible baselines against which to compare the current price (ask bid, today's opening price, yesterday's closing price, 50-day moving average, etc., represented here by Comp1, Comp2, . . . CompN); last volume (the number of shares traded); average volume; and a set of standard stock market metrics (e.g., the Dow Jones Industrial Average, the Standard and Poor Index, etc.).

When a structured news event (FIG. 7) is received by Distribution Agent 370, the publisher ID of that data event is looked up in the Preference table (FIG. 6), and all preferences involving that publisher are selected. For each preference involving that publisher, the subject, e.g. the security value, is compared, narrowing the set of matching preference records still further. Next, the selected comparison datum for each matching preference record is identified, and a calculation is made to determine whether that parameter has crossed the subscriber's preference threshold (by the specified percentage or beyond the specified fixed-price threshold, in the specified direction). For those preference records in which this criterion is met, Distribution Agent 370 looks up the delivery ID in the device table, and appends the device address, type, and carrier, together with the subscriber's selected comparison field from the content preference record, to a distribution list associated with the particular news event (FIG. 12), unless a distribution list is already provided by the data source.

FIG. 8 shows a record structure for an incoming unstructured news event. It contains the following fielded data: a unique event ID; publisher ID; domain (e.g., portfolio); subject (in the portfolio domain, this will be a security); category (e.g., management change, insider trading, analyst downgrade or upgrade, earnings warning); content owner (since the story may be copyrighted by the New York Times® even though it is distributed by Yahoo®); publication date and time; and editor or author. It also contains three free-text fields of arbitrary length, for the title, summary, and full text of the article. Finally, it contains the IDs of the reader who recorded the audio and/or video files and Quality Assurance analyst who cleared them, and pointers to the audio and video versions of the summary and the full text, and to any additional visuals.

When an unstructured news event (FIG. 8) is received by the Distribution Agent 370 (FIG. 2), the publisher ID of the data event is looked up in the preference table (FIG. 6), and all preferences involving that publisher are selected. For each preference involving that publisher, the subject, e.g. the security value, is compared, narrowing the set of matching preference records still further. For each such preference, the category field in the preference record is compared with the category field in the news event. For those preference records where subject and category are a match, Distribution Agent looks up the delivery ID in the device table, and appends the device address, type, and carrier, together with the subscriber's selection of summary or full text from the content preference record, to a distribution list associated with the particular news event (FIG. 13), unless a distribution list is already provided by the data source.

FIG. 9 shows a record structure for a subscriber profile, as constructed by third-party profiling software. The system may contain one, several, or no profiles for a given subscriber, depending on how many profiling “authorities” (e.g., VALS, Claritas, Nielson, particular publishers) have information about that particular subscriber. The record consists of a profile ID, an authority ID, a profile value, and a device address. Profiles behave very much like subscriber preferences within the system 10, with advertisements (FIG. 10) functioning as the associated “news events”.

FIG. 10 shows a record structure for an audio and/or visual advertisement. It consists of an advertisement ID, an advertiser, an authority ID, a profile value, a code for insertion order, and a pointer to the audio and/or visual advertisement, which is stored in the Library 390.

When an advertising record, see FIG. 10, is sent to system 10, its profile value field is compared with the profile value field in each profile record (see FIG. 9). For those profile records where the value is a match, Distribution gent 370 looks up the delivery ID in the playback device table, and appends the device address, type, and carrier to a distribution list associated with the particular advertisement. Advertisement records are sent to the appropriate device addresses when they are input to the system and the appropriate profile matches have been made.

FIG. 11 shows a record structure for subscriber playlist preferences. The options offered to the subscriber correspond to particular rules or constellations of rules, and are translated into records in this table. Each record consists of a unique preference ID, a rule ID, fields for optional supplementary information that the rule may require, and a device ID pointing back to the device table. Playlist generation rule preferences are sent to the appropriate play modules when the subscriber sets up preferences, or changes his/her preference configuration. Some of these preferences may also be embedded in the subscriber records in a distribution list associated with a structured or unstructured news event.

Referring to FIG. 12, a distribution list for a structured news event is illustrated. The news event is itself a record structure similar to that shown in reference to FIG. 7. The distribution data consists of a list of device IDs of the devices to which the news should be routed, along with type and carrier information; and subscriber specific information used by playlist generation rules or the playlist generation rules themselves; all of this information was collected from the delivery records shown in FIG. 5. Each entry on the distribution list is associated with a Comp (comparison) field drawn from the content preference record (FIG. 6). To continue with the portfolio example, this allows the system to keep track of the fact that the subscriber of device 9400 was interested in percentage increase over the opening price, while the subscriber of device 9412 was interested in percentage increase over yesterday's close, etc.

In FIG. 13, a distribution list for an unstructured news event is shown. The news event or advertisement is itself a record structure similar to that shown in FIG. 8. The distribution data consists of a list of device IDs of the devices to which the news should be routed, along with type and carrier information, and subscriber specific information used by playlist generation rules or the playlist generation rules themselves; all of this information was collected from the delivery records shown in FIG. 5. Each entry on the distribution list is associated with a selection of S (summary) or F (full text), indicating the subscriber's preference as to which to play.

Distribution lists for advertisements (not shown) are similar to the distribution lists shown in FIG. 12 and FIG. 13, except that the address, type, and carrier information is not associated with any additional fields. This is because advertisements are selected as whole entities, with no subscriber-defined variables involved. However, there may be variables set by other entities such as data source, carrier, and Evoxis.

With respect to FIGS. 4 through 13, examples of XML data representations are set forth below. These Document Type Definitions (DTDs) illustrate one way to communicate data from FIGS. 4 through 13 between various modules of System 10.

User Data:

A DTD for Sending Subscriber Contact Information and Preferences from Retail Portfolio Publisher 310 to Router 340:

```
<?xml version=“1.0” encoding=“UTF-8” ?>
<!-- This DTD defines XML for user registration events -->
<!ELEMENT userdata (publisherID, publisherPassword, userinfo, devices+, profile*)>
  <!ELEMENT publisherID (#PCDATA)>
  <!ELEMENT publisherPassword (#PCDATA)>
  <!ELEMENT userinfo (publisherUserID, first_name?, last_name?, email?, holdings*, content_preferences*)>
    <!ELEMENT publisherUserID (#PCDATA)>
    <!ELEMENT first_name (#PCDATA)>
    <!ELEMENT last_name (#PCDATA)>
    <!ELEMENT email (#PCDATA)>
    <!ELEMENT holdings (user_stock | user_fund)> <!-- represents the stocks and funds a user owns shares
in -->
      <!ELEMENT user_stock (name, symbol, exchange, transactionType, transactionPrice,
transactionDate, numberOfShares, commission)>
        <!ELEMENT name (#PCDATA)>
        <!ELEMENT symbol (#PCDATA)>
        <!ELEMENT exchange (#PCDATA)>
        <!ELEMENT transactionType EMPTY>
          <!ATTLIST transactionType transTypeName (buy | sell) “sell”>
        <!ELEMENT transactionPrice (#PCDATA)>
        <!ELEMENT transactionDate (#PCDATA)>
        <!ELEMENT numberOfShares (#PCDATA)>
        <!ELEMENT commission (#PCDATA)>
      <!ELEMENT user_fund (name, symbol, fund_org, transactionType, transactionPrice, transactionDate,
numberOfShares, commission)>
      <!ELEMENT fund_org (#PCDATA)>
    <!ELEMENT content_preferences (domain, category, subject, (fulltext | summary), trigger?)>
      <!ELEMENT domain EMPTY>
        <!ATTLIST domain domainName (Financial) “Financial”>
      <!ELEMENT category (#PCDATA)>
      <!ELEMENT subject (subjectName*)> <!-- list of symbols that this preference relates to -->
        <!ELEMENT subjectName (#PCDATA)>
      <!ELEMENT fulltext EMPTY>
        <!ATTLIST fulltext value (true | false) “true”>
      <!ELEMENT summary EMPTY>
        <!ATTLIST summary value (true | false) “true”>
      <!ELEMENT trigger (stockTrigger | indexTrigger | fundTrigger)>
        <!ELEMENT stockTrigger (stockComparisonCategory, stockTriggerValue)>
          <!ELEMENT stockComparisonCategory EMPTY>
            <!ATTLIST stockComparisonCategory catName (boughtAt | fiftyTwoWeekHigh |
fiftyTwoWeekLow | yesterdaysClosing | todaysOpening | fiftyDayMovingAverage |
twoHundredDayMovingAverage) “boughtAt”>
          <!ELEMENT stockTriggerValue (#PCDATA)>
            <!ATTLIST stockTriggerValue valType (dollars | percent) “dollars”>
        <!ELEMENT indexTrigger (indexComparisonCategory, indexTriggerValue)>
          <!ELEMENT indexComparisonCategory EMPTY>
            <!ATTLIST indexComparisonCategory catName (fiftyTwoWeekHigh |
fiftyTwoWeekLow | yesterdaysClosingIndex | todaysOpeningIndex | fiftyDayMovingAverage |
twoHundredDayMovingAverage) “todaysOpeningIndex”>
          <!ELEMENT indexTriggerValue (#PCDATA)>
        <!ELEMENT fundTrigger (fundComparisonCategory, fundTriggerValue)>
          <!ELEMENT fundComparisonCategory EMPTY>
            <!ATTLIST fundComparisonCategory catName (boughtAt | fiftyTwoWeekHigh |
fiftyTwoWeekLow | yesterdaysClosingPrice | todaysOpeningPrice | fiftyDayMovingAverage |
twoHundredDayMovingAverage) “boughtAt”>
          <!ELEMENT fundTriggerValue (#PCDATA)>
            <!ATTLIST fundTriggerValue valType (dollars | percent) “dollars”>
  <!ELEMENT devices (distributionChannel, deviceAddress, devType, playlist_preferences?)>
    <!ELEMENT distributionChannel (#PCDATA)>
    <!ELEMENT deviceAddress (#PCDATA)>
    <!ELEMENT devType EMPTY>
      <!ATTLIST devType typeName (cell | pc | mp3 | email) “cell”>
    <!ELEMENT playlist_preferences (domainOrdering, orderingScheme)>
      <!ELEMENT domainOrdering (domain, orderNumber)>
        <!ELEMENT orderNumber (#PCDATA)>
    <!ELEMENT orderingScheme EMPTY> <!-- this is global over all domains -->
      <!ATTLIST orderingScheme orderSchemeType (time | alphabetical) “time”>
  <!ELEMENT profile (#PCDATA)>
```

Quote:

A DTD for a Stock, Fund, or Index Quote:

```
<?xml version=“1.0” encoding=“UTF-8” ?>
<!-- This DTD defines XML that represents a quote for a stock, fund or index -->
<!ELEMENT quote (monetaryUnits, (stock | fund | index))>
  <!ELEMENT monetaryUnits EMPTY>
    <!ATTLIST monetaryUnits unitName (USD) “USD”>
  <!ELEMENT stock (exchange, name, symbol, last_trade, change, prev_close, volume, div_date, ex_div,
avg_vol, open, bid, ask, days_range, fifty_two_week_range, earn_per_share, p_e, mkt_cap, div_per_share?, yield?,
fifty_day_moving_average?, two_hundred_day_moving_average?)>
    <!ELEMENT exchange (#PCDATA)>
    <!ELEMENT name (#PCDATA)>
    <!ELEMENT symbol (#PCDATA)>
    <!ELEMENT last_trade (time, monetaryValue)>
      <!ELEMENT time (#PCDATA)>
      <!ELEMENT monetaryValue (#PCDATA)>
    <!ELEMENT change (monetaryValue)>
    <!ELEMENT prev_close (monetaryValue)>
    <!ELEMENT volume (#PCDATA)>
      <!ATTLIST volume degree (low | medium | high) “low”>
    <!ELEMENT div_date (#PCDATA)>
    <!ELEMENT ex_div (#PCDATA)>
    <!ELEMENT avg_vol (#PCDATA)>
    <!ELEMENT open (monetaryValue)>
    <!ELEMENT bid (monetaryValue)>
    <!ELEMENT ask (monetaryValue)>
    <!ELEMENT days_range (high, low)>
    <!ELEMENT high (monetaryValue)>
    <!ELEMENT low (monetaryValue)>
    <!ELEMENT fifty_two_week_range (high, low)>
    <!ELEMENT earn_per_share (monetaryValue)>
    <!ELEMENT p_e (#PCDATA)>
    <!ELEMENT mkt_cap (#PCDATA)>
    <!ELEMENT div_per_share (#PCDATA)>
    <!ELEMENT yield (#PCDATA)>
    <!ELEMENT fifty_day_moving_average (#PCDATA)>
    <!ELEMENT two_hundred_day_moving_average (#PCDATA)>
    <!ELEMENT fund (name, symbol, fund_org, net_asset_value, change, prev_close)>
    <!ELEMENT fund_org (#PCDATA)>
    <!ELEMENT net_asset_value (date, monetaryValue)>
      <!ELEMENT date (#PCDATA)>
  <!ELEMENT index (name, symbol, last_trade, days_range, fifty_two_week_range, change, prev_close, open,
volume, avg_vol)>
```

News Data:

A DTD for Sending Structured or Unstructured News Data with Associated Distribution List from Retail Portfolio Publisher 310 to Router 340:

```
<?xml version=“1.0“ encoding=“UTF-8” ?>
<!-- This DTD defines XML for a structured or unstructured news event -->
<!ENTITY % quote SYSTEM “quote.dtd”> <!-- define external reference -->
<?xml version=“1.0” encoding=“UTF-8” ?>
<!-- This DTD defines XML for a structured or unstructured news event -->
<!ELEMENT news (publisherID, publisherPassword, eventTime, contentOwner, domain, category, subject*, title?,
quote+, (unstructuredData | structuredData) )>
<!ELEMENT publisherID (#PCDATA)>
  <!ELEMENT publisherPassword (#PCDATA)>
  <!ELEMENT eventTime (#PCDATA)>
  <!ELEMENT contentOwner (#PCDATA)>
  <!ELEMENT domain EMPTY>
    <!ATTLIST domain domainName (Financial) “Financial”>
  <!ELEMENT category (#PCDATA)> <!-- enumerated list at some point -->
  <!ELEMENT subject (#PCDATA)> <!-- Stock symbol(s) of the company(ies) this news event pertains to -->
  <!ELEMENT title (#PCDATA)>
  %quote; <!-- insert quote.dtd here -->
  <!ELEMENT unstructuredData (author*, analyst*, text, distribution_list)>
    <!ELEMENT text (#PCDATA)>
    <!ELEMENT author (#PCDATA)>
    <!ELEMENT analyst (#PCDATA)>
  <!ELEMENT structuredData (distribution_list)>
    <!ELEMENT distribution_list (news_user_info+)>
      <!ELEMENT news_user_info (publisherUserID, triggers*)> <!-- triggers can be a trigger for a stock
or index -->
      <!ELEMENT publisherUserID (#PCDATA)>
      <!ELEMENT triggers (deviceAddress, monetaryUnits, (stockTrigger | indexTrigger | fundTrigger |
unstructuredTrigger))>
        <!ELEMENT deviceAddress (#PCDATA)>
        <!ELEMENT stockTrigger (stockComparisonCategory, stockTriggerValue, stockBaseData)>
          <!ELEMENT stockComparisonCategory EMPTY>
            <!ATTLIST stockComparisonCategory catName (boughtAt | fiftyTwoWeekHigh |
fiftyTwoWeekLow | yesterdaysClosingPrice | todaysOpeningPrice | fiftyDayMovingAverage |
twoHundredDayMovingAverage) “boughtAt”>
          <!ELEMENT stockTriggerValue (#PCDATA)>
            <!ATTLIST stockTriggerValue valType (dollars | percent) “dollars”>
          <!ELEMENT stockBaseData (#PCDATA)>
        <!ELEMENT indexTrigger (indexComparisonCategory, indexTriggerValue, indexBaseData)>
          <!ELEMENT indexComparisonCategory EMPTY>
            <!ATTLIST indexComparisonCategory catName (fiftyTwoWeekHigh |
fiftyTwoWeekLow | yesterdaysClosingIndex | todaysOpeningIndex | fiftyDayMovingAverage |
twoHundredDayMovingAverage) “todaysOpeningIndex”>
          <!ELEMENT indexTriggerValue (#PCDATA)>
          <!ELEMENT indexBaseData (#PCDATA)>
        <!ELEMENT fundTrigger (fundComparisonCategory, fundTriggerValue, fundBaseData)>
          <!ELEMENT fundComparisonCategory EMPTY>
            <!ATTLIST fundComparisonCategory catName (boughtAt | fiftyTwoWeekHigh |
fiftyTwoWeekLow | yesterdaysClosingPrice | todaysOpeningPrice | fiftyDayMovingAverage |
twoHundredDayMovingAverage) “boughtAt”>
          <!ELEMENT fundTriggerValue (#PCDATA)>
            <!ATTLIST fundTriggerValue valType (dollars | percent) “dollars”>
          <!ELEMENT fundBaseData (#PCDATA)>
        <!ELEMENT unstructuredTrigger EMPTY>
```

Market Wrap Up Data:

A DTD for Sending a Special Type of Unstructured News Event, Market Wrap-Up Data, with Associated Distribution List from Retail Portfolio Publisher 310 to Router 340:

```
<?xml version=“1.0” encoding=“UTF-8” ?>
<!-- This DTD defines XML for a daily market wrap up event -->
<!ENTITY % quote SYSTEM “quote.dtd”> <!-- define external
reference -->
%quote; <!-- insert quote.dtd here -->
<!-- NOTE: Must include quotes for ALL indices (S&P500, DOW,
etc) -->
<!ELEMENT wrapup (publisherID, publisherPassword, publishedTime,
unstructuredItem, quote+)>
  <!ELEMENT publisherID (#PCDATA)>
  <!ELEMENT publisherPassword (#PCDATA)>
  <!ELEMENT publishedTime (#PCDATA)>
  <!ELEMENT unstructuredItem (#PCDATA)>
```

Event from Distribution Manager (400) to Play (410, 420, and 430):

A DTD for Sending News or Ad Events with Carrier Specific Distribution Lists from Distribution Manager 400 to Play Modules 410, 420, and 430:

```
<?xml version=“1.0” encoding=“UTF-8” ?>
<!-- This DTD defines XML for news events that are sent from EvRAD to EvPlay -->
<!ENTITY % quote SYSTEM “quote.dtd”> <!-- define external reference -->
<!ELEMENT newEvent (eventtype, dlist+)>
  <!ELEMENT eventtype (newsEvent | adEvent | quote) >
    <!ELEMENT newsEvent (publisherID, eventTime, contentOwner, domain, category, subject,
(event_unstructuredData | event_structuredData) )>
      <!ELEMENT publisherID (#PCDATA)>
      <!ELEMENT eventTime (#PCDATA)>
      <!ELEMENT contentOwner (#PCDATA)>
      <!ELEMENT domain EMPTY>
        <!ATTLIST domain domainName (Financial) “Financial”>
      <!ELEMENT category (#PCDATA)> <!-- enumerated list at some point -->
      <!ELEMENT subject (#PCDATA)> <!-- Symbol of company that the news event is about -->
      <!ELEMENT event_unstructuredData (unstructuredEventInfo, unstructuredEventAudio+, quote*) >
        <!ELEMENT unstructuredEventInfo (title, fulltext, summary, author*, analyst*)>
        <!ELEMENT title (#PCDATA)>
        <!ELEMENT fulltext (#PCDATA)>
        <!ELEMENT summary (#PCDATA)>
        <!ELEMENT author (#PCDATA)>
        <!ELEMENT analyst (#PCDATA)>
        <!ELEMENT unstructuredEventAudio (eventID, voice, language, format, samplingRate, length,
audio)>
          <!ELEMENT eventID (#PCDATA)>
          <!ELEMENT voice (#PCDATA)>
          <!ELEMENT language EMPTY>
            <!ATTLIST language languageName (English) “English”>
          <!ELEMENT format EMPTY>
            <!ATTLIST format formatName (wav | mp3) “wav”>
          <!ELEMENT samplingRate (#PCDATA)>
          <!ELEMENT length (#PCDATA)>
          <!ELEMENT audio (#PCDATA)>
      <!ELEMENT event_structuredData (quote)>
      <!ELEMENT adEvent (#PCDATA)>
  <!ELEMENT dlist (userID, dlistID, event_trigger*) >
    <!ELEMENT userID (#PCDATA)>
    <!ELEMENT dlistID (#PCDATA)>
    <!ELEMENT event_trigger (deviceAddress, monetaryUnits, (stockComparison | indexComparison |
fundComparison | unstructuredComparison) ) >
      <!ELEMENT deviceAddress (#PCDATA)>
      <!ELEMENT monetaryUnits EMPTY>
        <!ATTLIST monetaryUnits unitName (USD) “USD”>
      <!ELEMENT stockComparison (stockComparisonCategory, stockTriggerValue, stockBaseData)>
        <!ELEMENT stockComparisonCategory EMPTY>
          <!ATTLIST stockComparisonCategory catName (boughtAt | fiftyTwoWeekHigh |
fiftyTwoWeekLow | yesterdaysClosingPrice | todaysOpeningPrice | fiftyDayMovingAverage |
twoHundredDayMovingAverage) “boughtAt”>
        <!ELEMENT stockTriggerValue (#PCDATA)>
          <!ATTLIST stockTriggerValue valType (dollars | percent) “dollars”>
        <!ELEMENT stockBaseData (#PCDATA)>
          <!ATTLIST stockBaseData units CDATA #FIXED “USD”>
      <!ELEMENT indexComparison (indexComparisonCategory, indexTriggerValue, indexBaseData)>
        <!ELEMENT indexComparisonCategory EMPTY>
          <!ATTLIST indexComparisonCategory catName (fiftyTwoWeekHigh | fiftyTwoWeekLow |
yesterdaysClosingIndex | todaysOpeningIndex | fiftyDayMovingAverage | twoHundredDayMovingAverage)
“todaysOpeningIndex”>
        <!ELEMENT indexTriggerValue (#PCDATA)>
        <!ELEMENT indexBaseData (#PCDATA)>
      <!ELEMENT fundComparison (fundComparisonCategory, fundTriggerValue, fundBaseData)>
        <!ELEMENT fundComparisonCategory EMPTY>
          <!ATTLIST fundComparisonCategory catName (boughtAt | fiftyTwoWeekHigh |
fiftyTwoWeekLow | yesterdaysClosingPrice | todaysOpeningPrice | fiftyDayMovingAverage |
twoHundredDayMovingAverage) “boughtAt”>
        <!ELEMENT fundTriggerValue (#PCDATA)>
          <!ATTLIST fundTriggerValue valType (dollars | percent) “dollars”>
        <!ELEMENT fundBaseData (#PCDATA)>
      <!ELEMENT unstructuredComparison EMPTY>
%quote; <!-- insert quote.dtd here -->
```

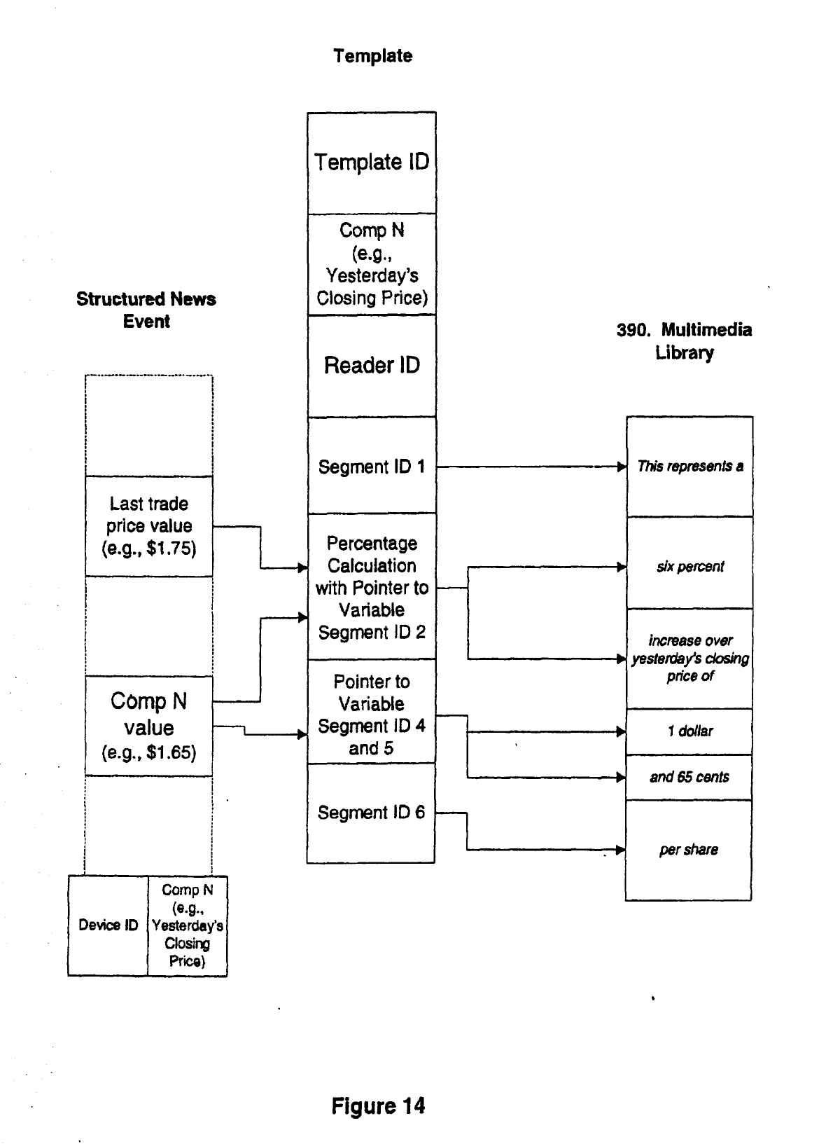

FIG. 14 shows a template for constructing sentences and their audio or video counterparts from a structured news event like the one in FIG. 7, together with distribution data as shown in FIG. 12. Each template has a template ID that is preferably an integer and is used to index the template in the database. The specific template is chosen in the Play modules 410, 420, 430, on the basis of the Comp (comparison) field associated with the particular device ID/address to which the news event has been sent. (For example, if the value of CompN for a given destination device is yesterday's closing price, then one of the CompN templates, all of which instantiate comparisons with yesterday's closing price, will be selected.) The template consists of pointers to fixed audio or video segments from Library 390, interspersed with pointers whose values are calculated on the basis of one or more data points in the structured news event, then looked up in the library. In the example shown in FIG. 14, the first segment (This represents a) comes directly from the library. The second segment is selected by calculating the percentage increase of the last trade price over the specified comparison price (here, yesterday's closing price), rounding the result, and selecting the corresponding audio or video segment from the library (six percent). The third segment (increase over yesterday's closing price of) is selected because the current price is greater than the comparison price. The fourth and fifth segments are selected on the basis of the value of the comparison price, which is looked up in the library (the segments one dollar and and sixty-five cents are selected separately). The sixth segment (per share) comes directly from the library. The set of segments selected by the template, when played in order, constitute one complete audio or video sentence. All segments used in a single template must have the same reader ID. Variable segments must match template constraints on category and intonation contour (e.g., follow-on, end of sentence, or contrast intonation).

Again, note that in an alternate embodiment, the system could generate text by using the templates to organize the text fields of the segments in the database, rather than to organize audio files. The text could then be delivered directly to a subscriber, for example as email, or could be converted to audio by a text-to-speech engine.

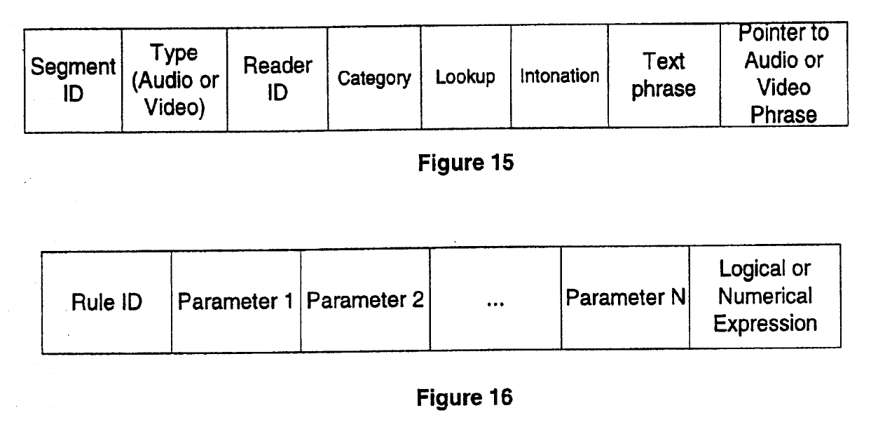

Referring to FIG. 15, a record structure for the storage of audio or video sentence segments and variable phrases is illustrated. Each record has a segment ID, and can be selected using a pointer to the segment ID—this is the method used for the fixed phrases in a template. The record also includes a reader ID and a type indicating audio or video. (A template can only select segments that have the same reader ID and the same type.) Next, it contains the text or numerical phrase that this record converts to audio or video—for example, “65 cents”. This field is used both for the convenience of those maintaining the database, and also in cases where the system is used to generate text rather than, or in addition to, audio or video. Next come the category and the lookup value, which are used in system lookup of variable information. For example, if the segment to be voiced is sixty-five cents, the correct audio or video segment can be found by selecting the record with category “cents” and lookup value “65”. The next field contains an intonation code, so that the system can choose the correct intonation contour for a particular position in a template. (For example, in a sentence like The stock rose $1.86 to $2.94 per share, eighty-six cents has follow-on intonation, while ninety-four cents has contrast intonation—ninety-FOUR cents. Most variable segments must be recorded multiple times to cover various intonation contours.) Finally, the record contains a pointer to the appropriate audio or video segment.

It should be noted that there is no table equivalent to that in FIG. 15 for the audio and video versions of full news stories, summaries, or advertisements. The unstructured news event or advertising record distributed in accordance with the distribution list already contains the audio and/or visual pointer required to convert those records to voice or visuals.

In FIG. 16, a record structure for playlist generation rules for organizing templates by vertical content (e.g., sports, weather, financial), paragraph, sentences, and clauses, is shown. Each rule consists of an ID number, one or more parameters used by the rule, and a logical expression to filter a list of events or a numerical expression to sort a list of events. Some playlist generation rules can be selected by subscribers, while others are defaults, selected by carrier, publisher, or other entities, or are non-configurable. These rules organize the news and manage the frame-to-audio conversion. In a preferred embodiment the system provides:

Subscriber Configurable

Order information by type/length (e.g., updates first, then summaries, then full texts);
Order information by publisher (e.g., Charles Schwab before T.D. Waterhouse);
Order information by domain (e.g., portfolio first, then weather, then sports); and
Order information by topic within a type, publisher, or domain (e.g., within Charles Schwab, order CPQ before IBM; within sports, order the Pirates before the Mets).
   Non-Subscriber Configurable
Select templates for structured data frames;
Organize the templates in such a way as to assemble coherent paragraphs (e.g., topic sentence, then new information, then background information); and
Insert sponsorship messages and/or advertisements at appropriate places.

While a subscriber can organize news by type, publisher, or domain, the playlist rules make sure that all information from a single publisher or on a single domain is delivered consecutively given that organization structure.

Once the playlist rules have selected a set of templates, the templates in turn select audio and/or video segments from the local copy of the multimedia library to assemble coherent sentences. As the playlist is assembled, complete audio and/or video files and discrete audio and/or video segments are played in order to output an organized, customized, natural-sounding news program tailored to the individual listener.

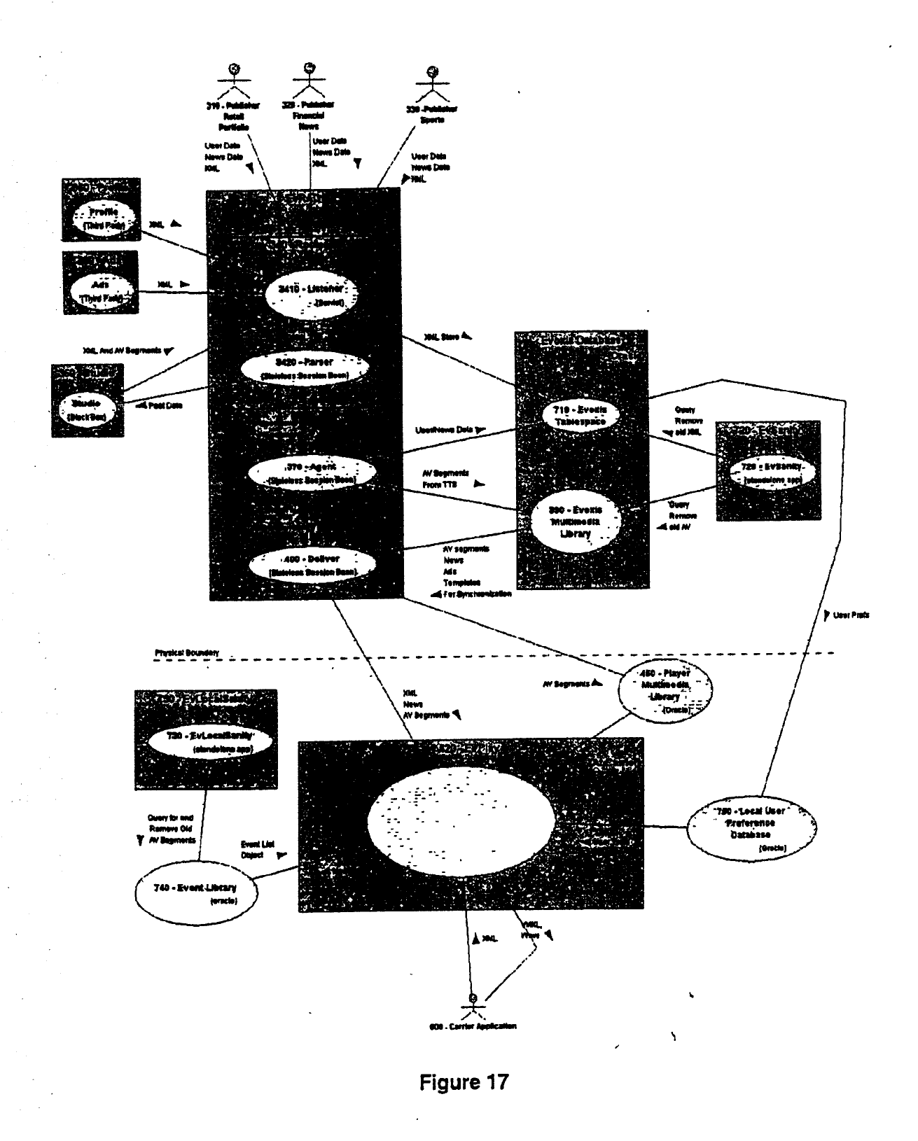

FIG. 17 shows one possible implementation of the system from FIG. 2 using Enterprise Java Beans and Oracle databases. In addition to the modules shown in FIG. 2, Tablespace 710 is the repository of subscriber information and incoming news events. EvSanity 720 is a stand-alone application that removes obsolete items from databases 710 and 390. It also monitors the XML data sent from data sources 310, 320, and 330 to ensure that Router 340 successfully processes them all. Router comprises modules Listener 3410 and Parser 3420. Listener 3410 receives data from the data sources and Parser 3420 converts the incoming XML data to Enterprise Java Beans and saves them to Tablespace 710. There are several modules that assist Play modules. FIG. 17 shows these components for Play module 420 from FIG. 2. Local User Preference Database 750 preferably stores delivery preferences for subscribers, Event Library 740 temporarily stores incoming data frames from Deliver 400, and EvLocalSanity 730, just like EvSanity 720, removes obsolete data items from databases 450 and 750. Data items corresponding to a data frame are obsolete when either all subscribers on the data frame's distribution list have heard the message or the maximum time a news event is stored for playback has lapsed.

While presently preferred embodiments have been described and shown, the invention may be otherwise embodied within the scope of the appended claims.

1. A system for converting and delivering multiple subscriber data requests to each subscriber according to a subscriber preference comprising:
A. a router for accepting a subscriber preference, distribution lists and data in at least one of structured and unstructured format from a data source of said subscriber, creating a data frame associated with each such data, and directing any of said unstructured data to a conversion means and any of said structured data to a distribution agent;
B. a first conversion means for converting unstructured textual data to at least one of audio or visual data and storing said converted data in a multimedia database library;
C. a multimedia database library for storing converted data, templates, media segments, media advertisements, and media news;
D. at least one second conversion means for converting structured data to an associated one of at least audio, visual or video;
E. a distribution agent for receiving structured data and subscriber preference data from said router and unstructured data frames from said conversion means and storing said data, augmenting distribution lists of subscribers, provided by said data source, with rules or parameters used by said rules to organize data for playback by subscribers, and delivering data with associated distribution lists to a distribution manager; and
F. a distribution manager for managing, over at least one network to at least one of said second conversion means, the distribution of subscriber data, converted data from said multimedia database library, and any templates stored therein for structured data, for delivery to a subscriber for playback of converted audio and/or visual data.

2. A system for converting and delivering multiple subscriber data requests to each subscriber according to a subscriber preference comprising:
A. a database module for accepting a subscriber preference, distribution lists and data in at least one of structured and unstructured format from a data source of said subscriber;
B. a first conversion means for obtaining any of said unstructured data from said database module conversion means, creating a data frame associated with each such data, and converting textual data to at least one of audio, video or visual data and storing said converted data in a multimedia database library;
C. a multimedia database library for storing converted data, templates, media segments, media advertisements, and media news;
D. at least one second conversion means for converting structured data to an associated one of at least audio, visual or video;
E. a distribution agent for obtaining structured data and subscriber preference data from said data module, creating a data frame associated with each such data, obtaining unstructured data frames from said first conversion means or said database module, storing said data, augmenting distribution lists of subscribers, provided by said data source, with rules or parameters used by said rules to organize data for playback by subscribers, and delivering data distribution lists to a distribution manager; and
F. a distribution manager for managing, over at least one network to at least one of said second conversion means, the distribution of subscriber data, converted data from said multimedia database library, and any templates stored therein for structured data, for delivery to a subscriber for playback of converted audio and/or visual data.

3. A system for use with a content provider service for systematically delivering preferred content to audio and/or visual devices of multiple users comprising:
A. a router for accepting, organizing and directing data received from a publisher application program interface, said data comprising user preferences and user preferred content as structured or unstructured data frames;
B. a first conversion means to augment said unstructured data frames with additional information, said additional information including identification and content summary, and create audio and/or visual files of said unstructured data;
C. a multimedia library containing segments of audio, visual or a combination thereof, and for storing at least one of said unstructured data frame audio and/or visual files, profiles and commercial/advertisement information;
D. a second conversion means for converting structured data to associated audio, visual or combination thereof;
E. a distribution agent to store in a database user preferences, structured data frames and augmented unstructured data frames and distribution rules; and
F. a distribution manager for systematically delivering said associated converted data to user devices according to said distribution list and rules.

4. A system for use with a content provider service for systematically delivering preferred content to audio and/or visual devices of multiple users comprising:
A. a database module for accepting data received from a publisher application program interface, said data comprising user preferences and user preferred content as structured or unstructured data frames;
B. a first conversion means to obtain said unstructured data frames from said database module, augment said unstructured data frames with additional information, said additional information including identification and content summary, and create audio and/or visual files of said unstructured data;
C. a multimedia library containing segments of audio, visual or a combination thereof, and for storing at least one of said unstructured data frame audio and/or visual files, profiles and commercial/advertisement information;
D. a second conversion means for converting structured data to associated audio, visual or combination thereof;
E. a distribution agent to obtain user preferences and structured data frames from said database module, obtain augmented unstructured data frames from first conversion means or said database module, store in a database said preferences, data frames, and distribution lists; and
F. a distribution manager for systematically delivering said associated converted data to user devices according to said distribution list and rules.

5. A system for use with a content provider service for systematically delivering preferred content to audio and/or visual devices of multiple users comprising:
A. a router for accepting, organizing and directing data received from a publisher application program interface, said data comprising user preferences and user preferred content as structured or unstructured data frames, whereby said router directs said unstructured text data to one or more first conversion means for converting said text data to audio or visual files and for augmenting said data with identification and file pointer information;
B. at least one first conversion means for converting unstructured data;
C. a multimedia library containing segments of audio, visual or a combination thereof for communicating with said conversion means through said pointers to assemble subscriber multimedia data;
D. at least one second conversion means for converting associated converted data; and
E. a distribution manager for systematically delivering said converted data for use by respective users.

6. A system for use with a content provider service for systematically delivering preferred content to audio and/or visual devices of multiple users comprising:
A. a database module for accepting data received from a publisher application program interface, said data comprising user preferences and user preferred content as structured or unstructured data frames, whereby one or more first conversion means obtains unstructured text data for converting said text data to audio or visual files and for augmenting said data with identification and file pointer information;
B. at least one first conversion means for obtaining unstructured data from said database module and converting said unstructured data;
C. a multimedia library containing segments of audio, visual or a combination thereof for communicating with said conversion means through said pointers to assemble subscriber multimedia data;
D. a distribution agent to obtain user preferences and user preferred content as structured data frames from said database module and obtain said augmented unstructured data frames from said first conversion source or said database module;
E. at least one second conversion means for converting associated converted data; and
F. a distribution manager for systematically delivering said converted data for use by respective users.

7. A system for converting and delivering multiple subscriber data requests as set forth in claim 1 or 2, where the distribution agent also prepares distribution lists of subscribers to receive data according to subscriber preference data, said distribution list including rules or parameters used by said rules to organize data for playback by subscribers.

8. A system for converting and delivering multiple subscriber data requests as set forth in claim 3 or 4, where the distribution agent also compares user preferences with said data frames and assembles a distribution list using said distribution rules.

9. A system for converting and delivering multiple subscriber data requests as set forth in claim 5 or 6, where the distribution agent also compares user preferences with converted text frames and assembles a distribution list.

10. A system for converting and delivering multiple subscriber data requests as set forth in any one of claims 1-6, including at least one play module having one of said second converters for accepting said subscriber data from said distribution manager.

11. A system for converting and delivering multiple subscriber data requests as set forth in claim 7 wherein said play module includes a library database for local storage of subscriber data received from said multimedia database library.

12. A system for converting and delivering multiple subscriber data requests as set forth in any one of claims 1-6, including a subscriber profile database for supplying customizable playlist rules to said distribution agent.

13. A system as set forth in any one of claims 1-6, wherein said first conversion means comprises at least one of software enabled speech and human talent speech.

14. A system for converting and delivering multiple subscriber data requests as set forth in any one of claims 1-6, including a database for storing advertising frames for said distribution manager to deliver to subscribers on a distribution list for an advertisement associated with said advertising frame.

15. A system for converting and delivering multiple subscriber data requests as set forth in claim 11 wherein said library database contains an advertisement associated with said advertising frame.

16. A system for converting and delivering multiple subscriber data requests as set forth in any one of claims 1-6, wherein said structured data is converted to at least one segment.

17. A system for converting and delivering multiple subscriber data requests as set forth in claim 13 wherein said library database includes at least one template to structure segments to create audio and/or visual communication media.

18. A system as set forth in any one of claims 1-6 wherein said structured data comprises formulaic or numeric data.

19. A system as set forth in any one of claims 1-6 wherein said first conversion means includes an automated text to speech program or a human recording studio.
